(19) United States
(12) Patent Application Publication
(10) Pub. No.: US 2020/0164539 A1
(43) Pub. Date: May 28, 2020

(54) AUTOMATED NOTCHING APPARATUS AND METHOD

(71) Applicant: MI INTÉGRATION S.E.N.C., Sherbrooke (CA)

(72) Inventors: Steve BLANCHETTE, Sherbrooke (CA); Charles DORÉ, Orford (CA)

(21) Appl. No.: 16/621,367

(22) PCT Filed: Jun. 12, 2018
(86) PCT No.: PCT/CA2018/050699

§ 371 Date: Dec. 11, 2019

Related U.S. Application Data
(60) Provisional application No. 62/518,327, filed on Jun. 12, 2017.

(51) Int. Cl. B26D 3/14; B26D 3/10; B26D 3/08; B26D 7/00; B26D 7/08; B25J 11/00

(52) U.S. Cl. CPC B26D 3/14; B26D 3/10; B25J 11/0055; B26D 7/0006; B26D 7/086; B26D 3/08

(57) ABSTRACT

A notching apparatus for notching an object comprises a movable notching head including two or more profiled slots, shaped and sized to receive a portion of the object, a notching tool coupled to the notching head for cutting a notch in the object when received within one of the profiled slots, a notching actuator connected to the notching tool for moving the tool relative to the head, and a multi-axis positioning device for positioning the notching head relative to the object to be notched so as to align one of the two or more profiled slots with the object to be notched.

### TECHNICAL FIELD

This invention relates generally to notching of objects. More specifically, this invention relates to apparatuses and methods for automated notching of objects such as automotive parts.

### BACKGROUND

Automatic notching devices for objects and, in particular, for extruded or molded articles are known in the art. However, the level of automation is often limited to simple linear objects and to notching at the end portions of such objects by cumbersome automatic notching machines. Such machines usually have an object support that immobilizes the object while leaving one or both ends of the object free to be inserted into an opening of a notching assembly. The notching assembly can be displaced back and forth (horizontally) and the object is inserted in a profiled slot by a sliding action. But this arrangement only one provide for a single notching pattern that can be realized with a particular notching assembly (even if the same pattern can be repeated several times along the object).

Furthermore, these automatic notching machines are poorly adapted for notching of objects exhibiting irregular shapes or for notching portions of objects away from extremities or at several locations on the object. Such processes currently require repositioning of the object with respect to a different notching machine to perform further notches. In addition to requiring extensive manual labor, repositioning creates variability in the accuracy of the notch leading to unacceptable proportions of rejected pieces.

There is therefore a need for improved automated notching apparatuses.

### SUMMARY

The following presents a simplified summary of some aspects or embodiments of the invention in order to provide a basic understanding of the invention. This summary is not an extensive overview of the invention. It is not intended to identify key or critical elements of the invention or to delineate the scope of the invention. Its sole purpose is to present some embodiments of the invention in a simplified form as a prelude to the more detailed description that is presented later.

A notching apparatus for notching an object, the apparatus comprising a movable notching head which includes two or more profiled slots, shaped and sized to receive a portion of the object, a notching tool connected to the head for cutting a notch in the object when received within one of the profiled slots, a notching actuator connected to the notching tool for moving the tool relative to the head; and a multi-axis positioning device for positioning the notching head relative to the object to be notched so as to align one of the two or more profiled slots with the object to be notched.

In another aspect there is provided a system comprising a notching apparatus as described above, an object support member, an object position detector, a controller and a processor to receive object position information from the object position detector, to provide the multi-axis positioning device positioning instructions to the controller for effecting the notching, the positioning instructions being function of the object position.

In another aspect there is provided a method for notching an object, the method comprising providing an notching apparatus or system, selecting a notching head corresponding to a predetermined notch profile, automatically positioning the notching head to receive a portion of the object to notch, and notching the object.

In another aspect there is provided a notching apparatus for notching an object, the apparatus comprising a movable notching head including at least one profiled slot that is shaped and sized to receive a portion of the object, a notching tool coupled to the notching head for cutting a notch in the object when received within one of the profiled slots, a notching actuator connected to the notching tool for positioning the tool, a multi-axis positioning device for positioning the notching head relative to the object to be notched so as to enable the at least one profiled slot to engage with the object to be notched.

### BRIEF DESCRIPTION OF THE DRAWINGS

The invention will be better understood by way of the following detailed description of embodiments of the invention with reference to the appended drawings, in which:

FIGS. 1A-1D are various views of the automated notching apparatus in accordance with one embodiment of the invention.

FIG. 2 is a perspective view of the notching apparatus in accordance with one embodiment of the invention with an object to be notched.

FIG. 3 is a perspective view of a robotic manipulator as one example of a multi-axis positioning device in accordance with one embodiment of the invention.

FIG. 4 is a perspective view of the notching head in accordance with one embodiment of the invention shown with an object to be notched.

FIG. 5 is a schematic representation of an embodiment of the notching apparatus.

FIG. 6 is a schematic representation of an embodiment of the notching apparatus showing the notching head engaged on an object.

FIG. 7 is an exploded view of a notching head showing the notching tool.

FIG. 8 is a cross-sectional view of an embodiment of the notching head showing the notching tool within a carrier.

FIG. 9 is a schematic representation of an embodiment of the notching apparatus showing the notching head with a knife-style blade.

### DETAILED DESCRIPTION

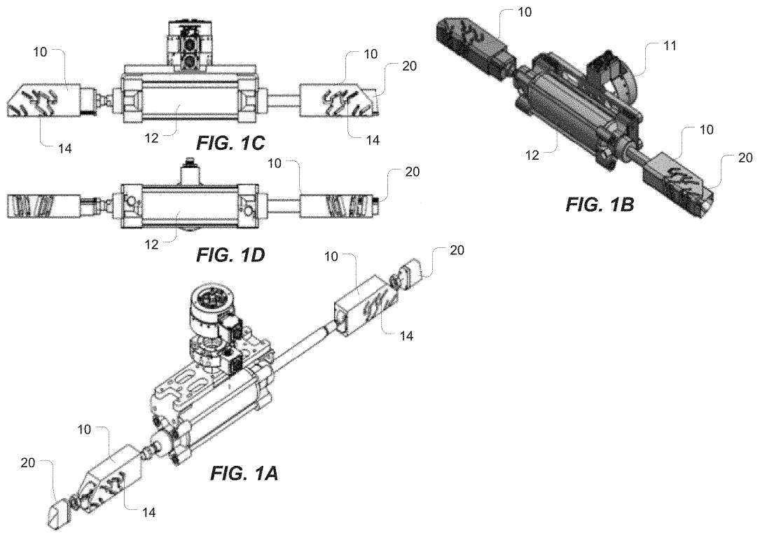

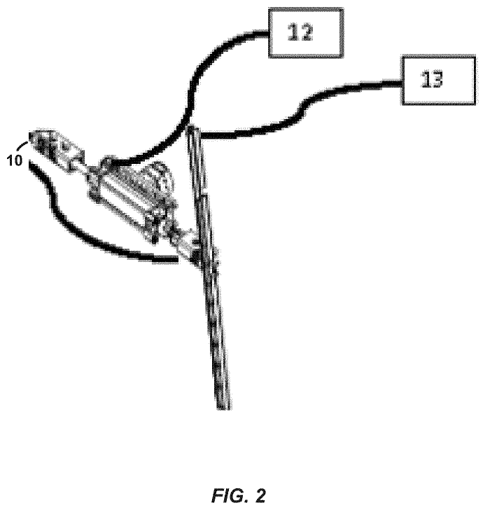

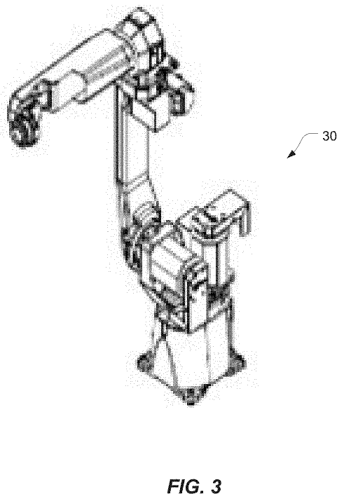

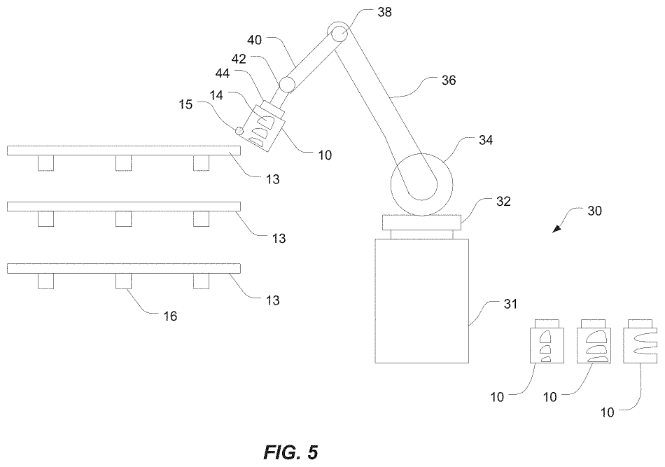

There is provided a notching apparatus (shown in different embodiments in FIGS. 1A-1D, 2, 3 and 4) having a notching head (or heads in the case of FIGS. 1A-1D and FIG. 2) 10 that is coupled or connected to a multi-axis positioning device 30 such as a multi-axis robot (see FIG. 5 for example) through a notching head connector 12 to enable positioning of the notching head 10 relative to an object 13 to be notched. In some implementations, the notch is an indentation, cutaway or incision that forms a groove within the object. In some implementations, the notch is V-shaped or U-shaped. In other implementations, the notch may have another shape. FIG. 2 provides a perspective view of a notching head associated with an object. Although not shown in FIG. 2, the object is immobilized (attached to an object support 16, as shown in FIG. 5 for example) during the notching operation.

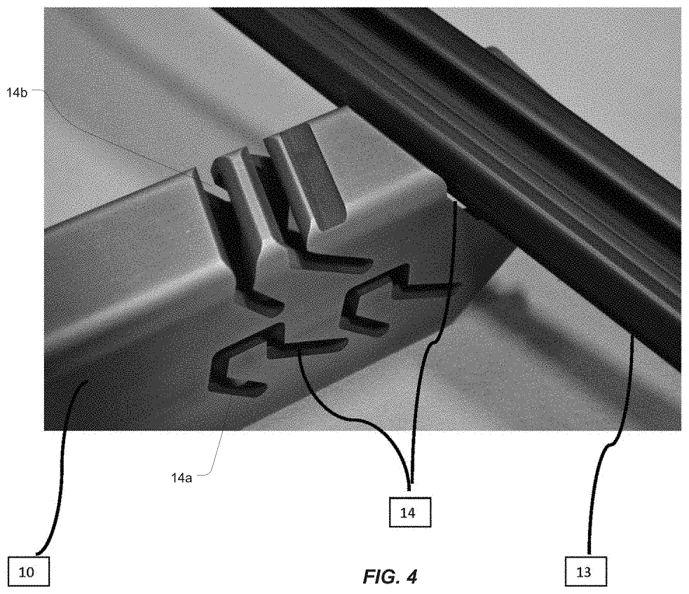

The notching head 10 is configured to receive a portion of the object to be notched (see, for example, FIG. 4) thereby positioning that portion of the object relative to a notch actuator that cooperates with the notching head to realize the notch. For example, profiled slots (openings) 14 in notching head 10 have a shape that is, at least in part, complementary to the portion of the object to be notched. Notching at a predetermined portion of the object may require more than one profiled slots 14 or combination of profiled slots. In at least some embodiments, the slots 14 are provided in both a first face of the notching head 10 and a second face of the notching head 10 that is spaced-apart and parallel to the first face as shown by way of example in FIGS. 1A-1D. In those embodiments, the object 13 may be inserted through the profiled slots 14 in both the first and second faces such that the object 13 is supported by the slots 14 in the first and second faces. In those embodiments, the object 13 held in the slots 14 may thus be notched by inserting the notching tool between the first and second faces.

More than one portion of the object may need to be notched. Thus the notching head 10 may comprise two or more sets of profiled slots 14 each set having different profiles or shapes and designed to notch different portions of the object with a different notch pattern. This advantageously enables notching at a plurality of locations on the object having different conformations while using the same notching head 10.

The profiled slots 14 may include “two-dimensional” slots 14a and “three-dimensional” slots 14b as depicted by way of example in FIG. 4. By two-dimensional slot it is meant that the profiled slot (or opening) is on a single face of the notching head and only allows the end portion of an object to be inserted in the profiled slot in a sliding manner. By three-dimensional slot it is meant that the profiled slot is continuous over a non-plane surface such as being continuous over at least two adjacent faces or two contiguous sides or over a curved surface of the notching head such that a portion of an object, which is not the end portion, can be inserted in the profiled slot 14b.

The notching head 10 is shown in the exemplary drawings as a rectangular tube (cuboid or box beam channel) having parallel faces. However, the notching head 10 may also have a different shape such as cylinder, triangular prism, cone and the like.

The combination of the three-dimensional profiled slots 14b and the multi-axis positioning device 30 enables the notching head to reach a part of the object to be notched without having to slide the notching head 10 along the object 13 from an end portion of the object. Not only does the arrangement provides additional flexibility to reach any desired position on the object but it also enables performing different notch patterns with the same notching head 10.

The object to be notched can be made of any material but the instant invention is particularly useful for notching resilient materials such as rubber, elastomers or certain types of plastic resins found, for examples, in automotive parts such as for example window seals and door seals. The invention, while not limited to, is particularly advantageous in the case of objects with complex shapes and configurations.

Resilient objects with complex configurations can be temporarily deformed or bent while being inserted in one of the profiled slots 14 and subsequently notched before relaxing to their original shape after the notching head 10 is pulled away from the object.

The notching head 10 is configured to cooperate with a notching tool 20 to effect the notching in the predetermined portion of the object. The notching tool 20 can be a die cutter (blade), an ultrasound transducer, a laser, a heat source or the like or a combination thereof. It will be appreciated that the type of notching tool used may depend on the nature of the material and the precision requirements of the notch.

With reference to FIGS. 1A-1D an embodiment of the invention is shown in which the notching actuator is a blade 20 that is slidably inserted in the notching head 10. In operation, the robot positions the notching head 10 at the portion of the object to be notched and once that portion is received within the profiled slot or slots 14 the notching is effected by sliding the blade in the notching head to come into contact with the portion of the object to be notched. In this case, the combination of the shape of the profiled slots 14 and of the blade 20 determines the shape of the notch on the object. It will be appreciated however that, depending on the nature of the notch actuator, the notching head 10 and profiled slots 14 may provide a means to orient the portion of the object to be notched such that the notch actuator and the notching tool can realize the notch in a pattern that is entirely dictated by the notch actuator. In other words, the shape of the notch on the object may be determined by the notching head 10 and the profiled slots 14, by a combination of the notching head 10, profiled slots 14 and the notch tool, or by the notch tool alone.

The notching head 10 may comprise a plurality of moving and cooperating parts that can dynamically create openings 14 with different configurations according to the requirements of the portion of the object to be notched and of the nature of the notch actuator. For example, the parts of the notching head 10 may be dynamically positioned while the portion of the object to be notched is being inserted therein to accommodate for complex object shapes. The actual motion sequence of the parts can be coordinated with the displacement of the notching head 10 effected by the position actuator.

Profiled slots 14 can collaborate with the multi-axis positioning device to dynamically insert the part of the object to be notched in the opening which may require to spatially orient the notching head as the object is being inserted in the opening. For example the initial insertion may be done at a particular angle and once part of the object is within the opening through the action of the position actuator, the notching head may be spatially re-oriented to continue or complete the insertion. This dynamic insertion is advantageous for relatively complex notch profiles.

The object can be mounted on an object support 16 that maintains the object in a fixed position while the position actuator moves the notching head 10 to predetermined portions of the object. The object support 16 may also be configured to move the object to one or more predetermined notching positions. For example, the object support 16 may position the object 13 for a first notch and then move the object 13 into a different position or orientation for a second notch and so forth. Thus, the object support 16 may collaborate with the multi-axis positioning device 30 and the notching head 10 to increase the positional flexibility in accessing different portions of the object 13 to be notched.

The object support 16 may also comprise movable parts that can be temporarily displaced, while the object is still maintained in a fixed position by other parts of the object support 16, to allow the notching head 10 access to portions of the object that would otherwise be inaccessible because of the object support.

The notching head 10 may also comprise additional functional structures that are either fixed or mobile and that facilitate the notching. The functional structures may include support structures that contribute to keeping the object in its optimal notching position while notching is performed by the notching actuator. For example, in the case where a blade is used to notch, the support structure may include a plate on which the portion of the object 13 to be notched rests and wherein the plate comprises a slit to allow the blade to go through the slit to complete the notching.

In another aspect, the functional structure may include a laser lens or mirror to direct the laser beam along the notching pattern when such a notching actuator is used. Other functional structures required by the nature of the notch actuator can be integrated with the notching head 10 as needed.

FIGS. 1A to 1D show embodiments in which the notching apparatus comprises two notching heads 10 one at each end of an elongated notching head connector 12. Such an arrangement, which is exemplary only, provides flexibility by allowing notching at two different positions of an object or on two different objects simultaneously. Thus multiple notching heads may be associated with the notching head connector 12. Furthermore, more than one notching head connector 12 may be used with a single multi-axis position actuator.

The apparatus advantageously enables replacement of the notching head 10. In one aspect, the replacement is automated by providing a notching head(s) store, such as a notching head(s) tray, rack, magazine, holder or carousel configured to cooperate with the multi-axis positioning device and the notching head connector 12 to disengage a notching head 10 from the notching head connector 12 and attach a different notching head 10 thereon. The notching head store may house a plurality of notching heads.

Depending on the requirements of the notching operation, the notching tool may be configured to remain with the notching head 10 when the notching head 10 is replaced. This advantageously allows the replacement of not only the notching head but also the type of notch actuator. Thus for a same object, a plurality of notches can be effected by a plurality of type of notch tools by the automated replacement of the notching head 10 on the notching head connector 12. Alternatively, only the notching head 10 may be replaced or only the notching tool. Thus, in one embodiment, the notching head 10 and the notching tool can be independently coupled or attached to the multi-axis positioning device.

In the embodiment illustrated in FIG. 5, the notching system includes a robotic manipulator 30 as one example of a multi-axis positioning device. In this particular embodiment, the robotic manipulator has a base 31, a first rotary joint 32, a second rotary joint 34, a first arm 36, a third rotary joint 38, a second arm 40, a fourth rotary joint 42, and an end effector 44 which may contain a further rotary joint. Another type of robotic manipulator can be used to achieve similar results. The end effector has one or more mounting points for mounting the notching head 10. The notching head 10 includes a plurality of differently sized and/or differently shaped profiled slots 14. This enables a single notching head to be used to perform different types of notching operations or act upon differently sized and/shaped objects. A position sensor 15 may be mounted to the profiled guide 10 or to any other suitable portion of the robotic manipulator 30 in order to sense a position of the object 13 to be notched. There may be multiple position sensors in other embodiments. The position sensor 15 may be, for example, a camera capable of capturing and transmitting digital images to a processor executing a machine-vision algorithm to determine a position of the object in three-dimensional space.

As illustrated by way of example in FIG. 5, there may be multiple objects 13 to be notched by the same robotic manipulator. In this example, there are three elongated objects 13 to be notched, each being held by respective object supports 16. In this embodiment, the object supports 16 are immobile; however, in other embodiments the object supports 16 may be movable. In one embodiment, one or more of the object supports 16 may be movable to provide access to the object being notched. For example, the motion of the robotic manipulator 30 may be coordinated with the movement of the one or more object supports 16 to enable the robotic manipulator 30 to access the object 13 to be notched.

As illustrated by way of example in FIG. 5, there may be multiple notching heads (profiled guides) 10 accessible and interchangeable by the robotic manipulator 30. The robotic manipulator 30 can select, either automatically or in response to user input, the notching head (profiled guide) for the object to be notched and based on the type of notch that is desired. Automatic selection of the notching head may optionally involve a step of automatically identifying the notching head. The notching head, in one embodiment, may have a machine-readable identifier, tag or code. This may be an RFID tag, an optically scanned code (bar code or QR code) or equivalent.

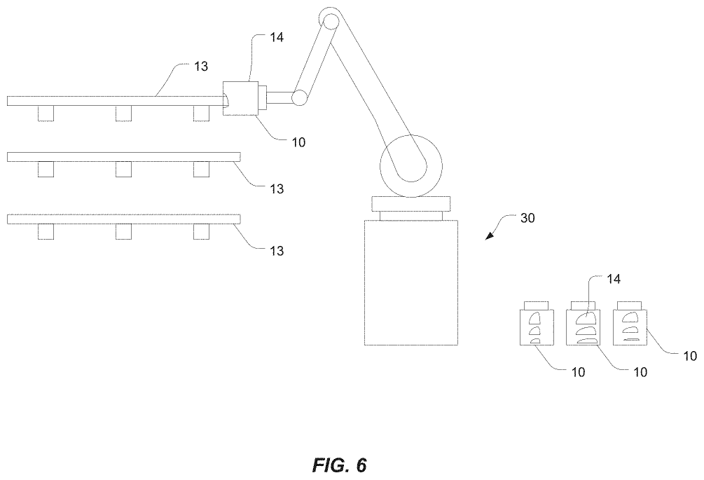

FIG. 6 depicts the robotic manipulator 30 aligning the notching head 10 with the object 13 to be notched. Once aligned, the robotic manipulator 30 slides the notching head 10 over the object 13 to the desired depth and then performs the notching operation before retracting. In some cases, the robotic manipulator 30 stops or pauses at multiple locations along the object to perform multiple notching operations.

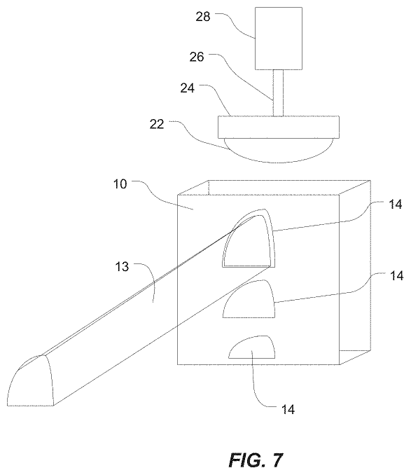

FIG. 7 is an enlarged view depicting the object 13 inserted into one of the profiled slots or openings 14 of the notching head 10. A notching tool, e.g. a blade 22, is mounted via a blade holder 24 to an actuator having a piston rod 26 and cylinder 28. Any other suitable mechanism may be used to displace the blade 22 to cut the notch on the object 13.

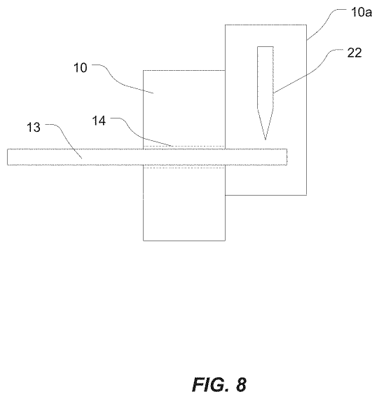

FIG. 8 is a side view of an object 13 inserted into an opening or slot 14 of a notching head 10. A guillotine-style notching tool or blade 22 is held inside a carrier 10a that is slidably mounted to a back face of the notching head 10. The carrier 10a is slidable to cause the blade 22 to notch the object 13. Although the blade 22 is shown as being orthogonal to the object 13, it will be appreciated that the blade 22 may be angled obliquely relative to the object 13.

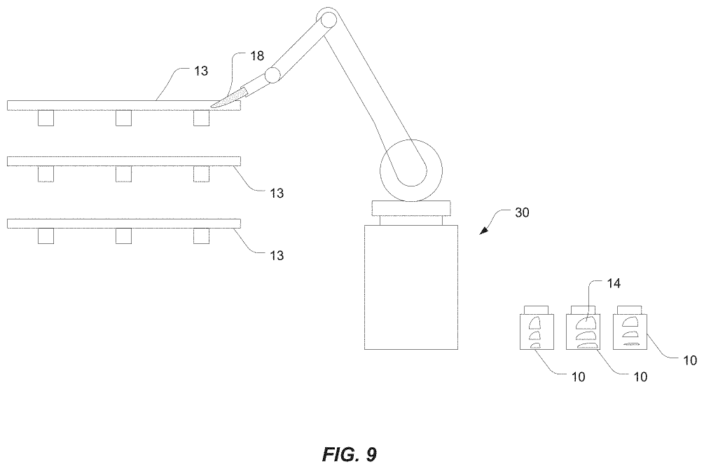

In the embodiment depicted in FIG. 9, the robotic manipulator 30 may also be adapted to hold a knife-style cutting blade 18 for slicing a groove into an object 13. The end effector of the robotic manipulator may grip the knife-style cutting blade using finger-like grippers. Alternatively, an adaptor plate may be mounted to the blade 18 to enable rapid attachment and detachment to and from the end effector.

In another embodiment, the multi-axis positioning device may be a multi-axis gantry or a gantry carrying a manipulator arm.

In another embodiment there is provided a system comprising a notching apparatus as described above, an object position register, a controller, and a processor to receive object position information from the object position detector and to provide positioning instructions to the controller for the multi-axis positioning device to effect notching, the positioning instructions being a function of the object position.

The automated parts of the system are connected to the controller which is programmed to trigger the various actions in the appropriate sequence. The controller may comprise a notching head controller which provides triggers, signals or commands for the automated functions of the notching head 10.

The system may also comprise an object position registering tool such as a position sensor 15, as described above. The position sensor may be, for example, a camera transmitting digital images to a processor executing a machine-vision algorithm to determine a position of the object in three-dimensional space. Alternatively, the position sensor may be a non-imaging optical sensor or an ultrasonic sensor.

The object position registering tool provides information on the position of the notching portion and the notching profile relative to other parts of the object and to a reference position framework to generate precise spatial coordinates instructions to the multi-axis positioning device through the controller. Such an arrangement can improve the accuracy of the notching by nullifying the effect of object positioning variations that may result either from a human operator or object support imprecisions or small displacements of the object during the process.

The system may also comprise an object feeder or conveyor that cooperates with the object(s) support 16 to automatically position the object(s). The object feeder (conveyor) may be coupled to the processor. The object feeder or conveyor may also be connected to an upstream extrusion machine that produces the object to be notched.

The notching apparatus and system of the present invention can advantageously be coupled to processes in the manufacturing of the object 13 to be notched. In a non-limiting example the notching apparatus may be coupled to an apparatus for the application of a thermosetting tape such as that described in PCT Patent Application WO/2017/049390A1 incorporated herein by reference in its entirety. Thus, in one embodiment, a thermosetting tape is applied on object 13 using the apparatus described in WO/2017/049390A1 and the notching head 10 and the notching tool (such as blade 20) can be configured to be associated with the tape laying head of the tape laying apparatus. In other words, the notching head connector 12 can be connected to the tape laying head of WO/2017/049390A1. The notching can thereby be synchronized with another process, in this case a thermosetting tape application. For example the notching head 10 can be positioned downstream of the tape contact member described in WO/2017/049390A1 and realize notches on the object after the tape has been applied to a portion of the object or after the entire tape application process has been completed.

Alternatively, the notching head 10 can be attached to a position actuator distinct from the tape laying head of WO/2017/049390A1 while sharing the object support. Thus the object can be positioned on the object support and undergo two or more processing operations one of which being notching with the apparatus of the present invention.

In another aspect of the invention there is also provided a method for notching an object comprising providing a notching apparatus or system as described above, selecting a notching head 10 corresponding to a predetermined notch profile, automatically positioning the notching head to receive a portion of the object to notch and then notching the object. The step of selecting a notching head 10 may include changing the notching head 10 based on the type of notch to be performed. Furthermore the method may include steps of registering the profile shape and position with a position detector.

It is to be understood that the singular forms “a”, “an” and “the” include plural referents unless the context clearly dictates otherwise. Thus, for example, reference to “a device” includes reference to one or more of such devices, i.e. that there is at least one device. The terms “comprising”, “having”, “including”, “entailing” and “containing”, or verb tense variants thereof, are to be construed as open-ended terms (i.e., meaning “including, but not limited to,”) unless otherwise noted. All methods described herein can be performed in any suitable order unless otherwise indicated herein or otherwise clearly contradicted by context. The use of examples or exemplary language (e.g. “such as”) is intended merely to better illustrate or describe embodiments of the invention and is not intended to limit the scope of the invention unless otherwise claimed.

This invention has been described in terms of specific embodiments, implementations and configurations which are intended to be exemplary only. Persons of ordinary skill in the art will appreciate, having read this disclosure, that many obvious variations, modifications and refinements may be made without departing from the inventive concept(s) presented herein. The scope of the exclusive right sought by the Applicant(s) is therefore intended to be limited solely by the appended claims.

1. A notching apparatus for notching an object, the notching apparatus comprising:
a movable notching head including:
two or more profiled slots, shaped and sized to receive a portion of the object;
a notching tool coupled to the movable notching head for cutting a notch in the object when received within one of the two or more profiled slots;
a notching actuator connected to the notching tool for moving the notching tool relative to the movable notching head;
a multi-axis positioning device for positioning the movable notching head relative to the object to be notched so as to align one of the two or more profiled slots with the object to be notched.

2. The notching apparatus of claim 1 wherein at least one of the two or more profiled slots is configured to receive an end portion of the object by sliding the end portion of the object into the at least one of the two or more profiled slots.

3. The notching apparatus of claim 1 wherein one of the two or more profiled slots is configured to receive a portion of the object other than an end portion of the object.

4. The notching apparatus of claim 3 wherein the one of the two or more profiled slots is continuous over a non-plane surface of the movable notching head.

5. The notching apparatus of claim 4 wherein the one of the two or more profiled slots is continuous over at least two contiguous sides of the movable notching head.

6. The notching apparatus of claim 1 wherein the movable notching head is removably mounted on the multi-axis positioning device.

7. The notching apparatus of claim 1 wherein the movable notching head is movable relative to the multi-axis positioning device.

8. The notching apparatus of claim 1 wherein the two or more profiled slots comprise dynamically adjustable moving parts to dynamically receive a portion of the object.

9. The notching apparatus of claim 1 wherein the notching tool is selected from a die cutter, an ultrasound transducer, a laser or a combination thereof.

10. The notching apparatus of claim 1 wherein the notching tool is a die cutter and is slidably mounted within the notching head.

11. The notching apparatus of claim 1 wherein the notching head further comprises means for supporting the portion of the object to be notched or portion adjacent thereof to maintain the shape of the object during notching.

12. The notching apparatus of claim 1 wherein the portion of the object to be notched is resilient and wherein the movable notching head is configured to temporarily bend to create a predetermined notch profile.

13. (canceled)

14. A system comprising:
the notching apparatus of claim 1,
an object support member,
an object position detector,
a controller, and
a processor to receive object position information from the object position detector and to provide positioning instructions to the controller for the multi-axis positioning device to effect notching, the positioning instructions being a function of the object position.

15. The system of claim 14 wherein the object position detector is optical.

16. The system of claim 14 further comprising a notching heads store comprising a plurality of notching heads accessible by the multi-axis positioning device.

17. The system of claim 14 further comprising a processing unit configured to subject the object to a process other than notching, wherein the notching apparatus is configured to collaborate with the processing unit to notch the object.

18. The system of claim 17 wherein the process other than notching is tape laying.

19-20. (canceled)

21. A notching apparatus for notching an object, the apparatus comprising:
a movable notching head including:
at least one profiled slot that is shaped and sized to receive a portion of the object;
a notching tool coupled to the notching head for cutting, cooperatively with the at least one profiled slot, a notch in the object when received within one of the profiled slots;
a notching actuator connected to the notching tool for positioning the notching tool;
a multi-axis positioning device for positioning the movable notching head relative to the object to be notched so as to enable the at least one profiled slot to engage with the object to be notched.

22. The notching apparatus of claim 20 further comprising a position detector for determining a position of the object.

23-27. (canceled)
